(19) United States
(12) Patent Application Publication
(10) Pub. No.: US 2023/0381889 A1
(43) Pub. Date: Nov. 30, 2023

(54) LASER PROCESSING SYSTEM AND CONTROL METHOD

(71) Applicant: FANUC CORPORATION, Yamanashi (JP)

(72) Inventor: Atsushi MORI, Yamanashi (JP)

(73) Assignee: FANUC CORPORATION, Yamanashi (JP)

(21) Appl. No.: 18/247,618

(22) PCT Filed: Oct. 14, 2021
(86) PCT No.: PCT/JP2021/038029

§ 371 Date: Mar. 31, 2023

(30) Foreign Application Priority Data
Oct. 16, 2020 (JP) 2020-174436

(51) Int. Cl. B23K 26/082; B23K 26/08

(52) U.S. Cl. CPC B23K 26/082; B23K 26/0876

(57) ABSTRACT

Provided is a laser processing system with which correction of a path of a laser illumination point can be carried out easily. This laser processing system is provided with a scanner, a moving device, a scanner control device for controlling the scanner, and a program generation device, wherein the program generation device converts a scanner program to a control point correction program for correcting a preset control point, the scanner control device has a trajectory control unit for controlling the scanner on the basis of the control point correction program such that a workpiece is illuminated with a control point correction trajectory for correcting the control point in a state in which the movement device is stopped, and the trajectory control unit controls the scanner on the basis of the control point correction program such that the control point correction trajectory is repeatedly scanned at predetermined intervals.

### TECHNICAL FIELD

The present invention relates to a laser processing system and a control method thereof.

### BACKGROUND ART

Conventionally, a laser processing system has been proposed in which a workpiece is irradiated with a laser beam from a position away from the workpiece to perform welding. In the laser processing system, a scanner that emits a laser beam is provided at the tip of an arm of a robot. The axes of the robot of the laser processing system are driven in accordance with a program stored in advance in a control device similarly to other industrial robots. Therefore, teaching work for creating a program using an actual machine and a workpiece is performed at a work site (for example, see Patent Document 1).

Patent Document 1: Japanese Unexamined Patent Application, Publication No. 2012-135781

### DISCLOSURE OF THE INVENTION

### Problems to be Solved by the Invention

When laser processing is performed using such a laser processing system, a deviation between the path of a laser irradiation point in the program and the actual path of the laser irradiation point becomes an issue.

Since the path of the laser irradiation point can be considered to be represented by a sequence of points in a coordinate system with respect to the base of the robot in a workspace, these points are referred to as control points. The control point may be a point on the path of the laser irradiation point, or may be a point that is not on the path of the laser irradiation point but is necessary to define the path of the laser irradiation point, such as the center of an arc.

A robot program and a scanner program are generated according to the position of each control point and each point of the direction (coordinate system of the control points) set in the program generation device of the laser processing system. However, a CAD data and the actual workpiece do not coincide with each other, and there are positional errors in the operation path of the robot, jigs, and the like. Therefore, it is necessary to teach and correct such a deviation and errors.

In addition, when combining a robot with a scanner in a laser processing system, a tool-center point (TCP) may need to be corrected. The TCP is represented by a position vector from the robot tip point to the scanner reference point. By correctly setting the TCP, the laser irradiation position on the program coincides with the actual laser irradiation position regardless of the posture of the robot.

Conventionally, correction of the control point and setting of the TCP have been performed using a teaching jig indicating a specific point immediately below the scanner. Usually, the specific point is the origin of the workspace of the scanner, and is set to a point where the laser is focused.

To indicate the specific point, a teaching jig made of metal, resin, or the like is used, or a plurality of additional guide lasers are crossed and the intersection is visually recognized. In either method, since the coordinates of one point immediately below the scanner are acquired, it is necessary to operate the robot to match a desired position on the actual workpiece with the specific point, which is not efficient.

In addition, in the conventional method, it is necessary to attach a teaching jig to the robot and to install an additional guide laser on the scanner. Therefore, a laser processing system capable of easily correcting a control point without requiring a teaching jig, an additional guide laser, or the like has been awaited.

### Means for Solving the Problems

A laser processing system according to the present disclosure includes a scanner capable of scanning a workpiece with a laser beam, a moving device configured to move the scanner relative to the workpiece, a scanner control device configured to control the scanner, and a program generation device configured to generate a scanner program for controlling the scanner by the scanner control device. The program generation device converts the scanner program into a control point correction program for correcting a preset control point. The scanner control device includes a trajectory control unit configured to control the scanner based on the control point correction program so as to illuminate the workpiece with a control point correction trajectory for correcting the control point in a state in which the moving device is stopped. The trajectory control unit controls the scanner based on the control point correction program so as to repeatedly scan the control point correction trajectory at a predetermined cycle.

A method for controlling a laser processing system according to the present disclosure includes converting a scanner program for controlling a scanner into a control point correction program for correcting a preset control point, moving the scanner capable of scanning a workpiece with a laser beam, relative to the workpiece, stopping a moving device configured to move the scanner relative to the workpiece, and controlling the scanner based on the control point correction program so as to illuminate the workpiece with a control point correction trajectory for correcting a preset control point in a state in which the moving device is stopped. Controlling the scanner includes controlling the scanner to repeatedly scan the control point correction trajectory at a predetermined cycle.

### Effects of the Invention

According to the present invention, it is possible to easily correct a control point.

### BRIEF DESCRIPTION OF THE DRAWINGS

FIG. 1 shows the overall configuration of a laser processing system according to the present embodiment;

FIG. 2 is a diagram for illustrating the optical system of a scanner in the laser processing system according to the present embodiment;

FIG. 3 is a block diagram showing the functional configuration of the laser processing system according to the present embodiment;

FIG. 4 is a block diagram showing the functional configuration of a scanner control device according to the present embodiment;

FIG. 5A shows an example of a scanner program before conversion;

FIG. 5B shows a control point correction program after conversion;

FIG. 6 shows an example of a control point correction trajectory emitted using a control point correction program;

FIG. 7 shows another example of a control point correction trajectory emitted using a control point correction program; and

FIG. 8 is a flowchart showing the flow of processing of the laser processing system according to the present embodiment.

### PREFERRED MODE FOR CARRYING OUT THE INVENTION

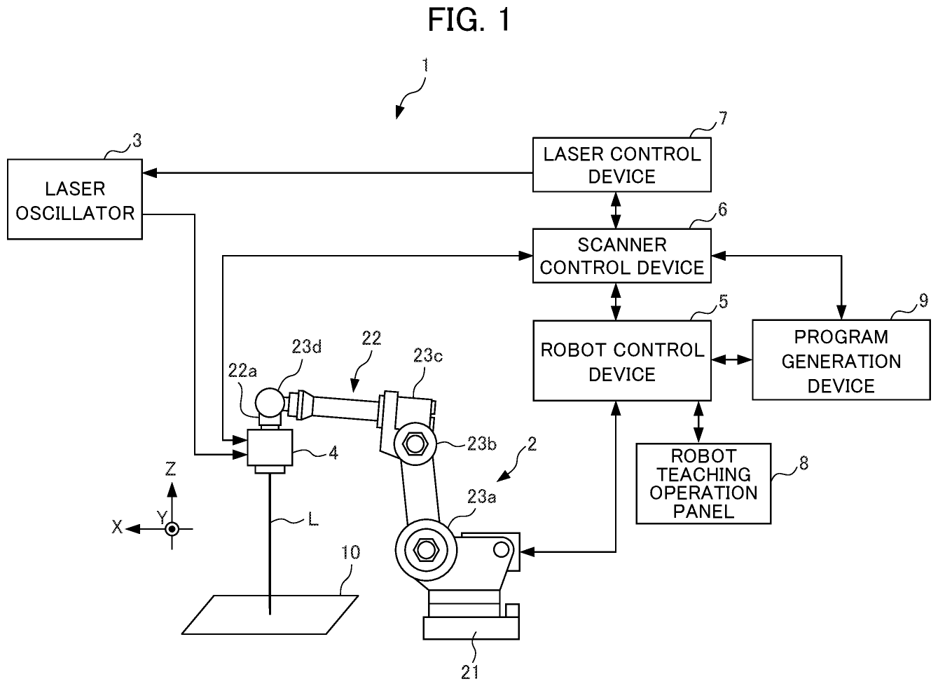

Embodiments of the present invention will now be described with reference to the drawings. FIG. 1 shows the overall configuration of a laser processing system 1 according to the present embodiment. The laser processing system 1 shown in FIG. 1 shows an example of a remote laser welding robot system.

The laser processing system 1 includes a robot 2, a laser oscillator 3, a scanner 4, a robot control device 5, a scanner control device 6, a laser control device 7, a robot teaching operation panel 8, and a program generation device 9.

The robot 2 is, for example, an articulated robot having a plurality of joints. The robot 2 includes a base 21, an arm 22, and a plurality of joint axes 23a to 23d each having a rotation axis extending in a Y direction.

Further, the robot 2 includes a plurality of robot servo motors, such as a robot servo motor that causes the arm 22 to rotationally move with a Z direction as a rotation axis, and a robot servo motor that causes the arm 22 to move in an X direction by rotating the joint axes 23a to 23d. Each of the robot servo motors rotationally drives based on drive data from the robot control device 5 described later.

The scanner 4 is fixed to a leading end portion 22a of the arm 22 of the robot 2. Accordingly, the robot 2 can move the scanner 4 to any position and any orientation in a workspace at a predetermined robot speed by the rotational drive of each robot servo motor. That is, the robot 2 is a moving device that moves the scanner 4 relative to a workpiece 10. In the present embodiment, the laser processing system 1 uses the robot 2 as a moving device, but the present invention is not limited thereto. For example, a three-dimensional machining device may be used as a moving device.

The laser oscillator 3 includes a laser medium, an optical resonator, and an excitation source. The laser oscillator 3 generates a laser beam with laser output based on a laser output command from the laser control device 7 described later, and supplies the generated laser beam to the scanner 4. Examples of the type of laser to be oscillated include a fiber laser, a CO₂ laser, and a YAG laser. The type of laser is not limited in the present embodiment.

The laser oscillator 3 can output a processing laser for machining the workpiece 10 and a guide laser for adjusting the processing laser. The guide laser is a visible laser adjusted on the same axis as the processing laser.

The scanner 4 receives a laser beam L emitted from the laser oscillator 3 and can scan the workpiece 10 with the laser beam L.

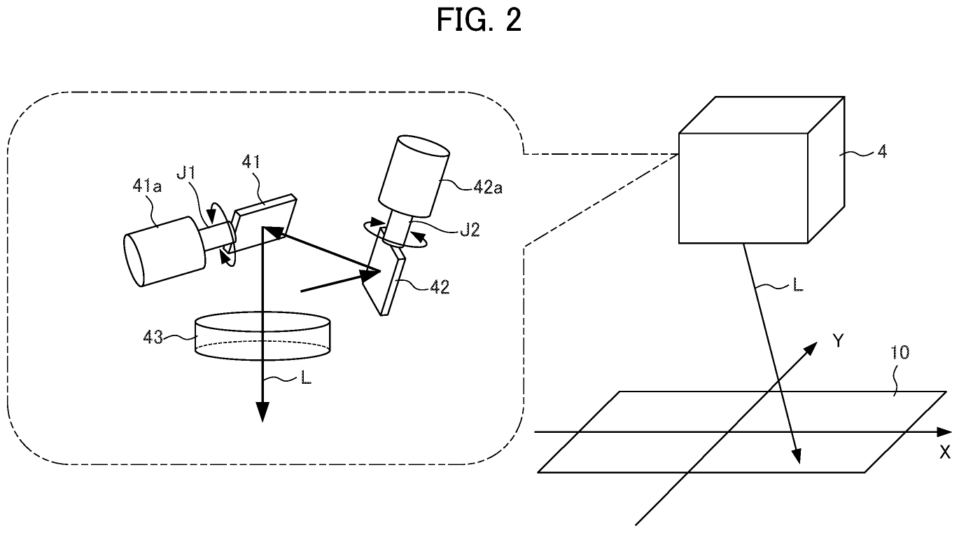

FIG. 2 is a diagram for illustrating the optical system of the scanner 4 in the laser processing system 1 according to the present embodiment. As shown in FIG. 2, the scanner 4 includes, for example, two galvano mirrors 41 and 42 that reflect the laser beam L emitted from the laser oscillator 3, galvano motors 41a and 42a that rotationally drive the galvano mirrors 41 and 42, respectively, and a cover glass 43.

The galvano mirrors 41 and 42 are configured to be respectively rotatable around two rotation axes J1 and J2 orthogonal to each other. The galvano motors 41a and 42a rotationally drive based on the drive data from the laser control device 7 to independently rotate the galvano mirrors 41 and 42 around the rotation axes J1 and J2.

The laser beam L emitted from the laser oscillator 3 is sequentially reflected by the two galvano mirrors 41 and 42, then is emitted from the scanner 4, and reaches a processing point (welding point) of the workpiece 10. At this time, when the two galvano mirrors 41 and 42 are respectively rotated by the galvano motors 41a and 42a, the incident angles of the laser beam L incident on the galvano mirrors 41 and 42 continuously change. As a result, the workpiece 10 is scanned with the laser beam L from the scanner 4 along a predetermined path, and a welding trajectory is formed on the workpiece 10 along the scanning path of the laser beam L.

The scanning path of the laser beam L emitted from the scanner 4 onto the workpiece 10 can be optionally changed in the X and Y directions by controlling the rotational drive of the galvano motors 41a and 42a as appropriate to change the rotation angles of the galvano mirrors 41 and 42.

The scanner 4 also includes a zooming optical system (not shown) capable of changing the positional relationship with a Z-axis motor. The scanner 4 can optionally change the laser irradiation point in the Z direction by moving, in an optical axis direction, the point where the laser is focused, by the drive control of the Z-axis motor.

The cover glass 43 is disk-shaped, and has a function of transmitting the laser beam L sequentially reflected by the galvano mirrors 41 and 42 toward the workpiece 10 and protecting the inside of the scanner 4.

The scanner 4 may be a trepanning head. In this case, the scanner 4 can have, for example, a configuration in which, a lens having one inclined surface is rotated by a motor to refract the incident laser and irradiate to any location.

The robot control device 5 outputs drive control data to each robot servomotor of the robot 2 in accordance with a predetermined robot program to control the operation of the robot 2. Further, the robot control device 5 commands the laser control device 7 to perform laser irradiation. The commands from the robot control device 5 may include power, frequency, and duty, which are laser irradiation conditions. The irradiation conditions may be stored in advance in a memory in the laser control device 7. The commands from the robot control device 5 may include the selection of irradiation conditions and the timing of starting and ending irradiation.

The scanner control device 6 adjusts the positions of the lens and mirrors in the mechanism of the scanner 4. The scanner control device 6 may be incorporated in the robot control device 5.

The laser control device 7 controls the laser oscillator 3, and controls it to output a laser beam in response to a command from the scanner control device 6. Not only may the laser control device 7 be connected to the scanner control device 6, but the laser control device 7 may also be directly connected to the robot control device 5. Alternatively, the laser control device 7 may be integrated with the scanner control device 6.

The robot teaching operation panel 8 is connected to the robot control device 5, and is used by an operator to operate the robot 2. For example, the operator inputs machining information for performing laser processing through a user interface on the robot teaching operation panel 8.

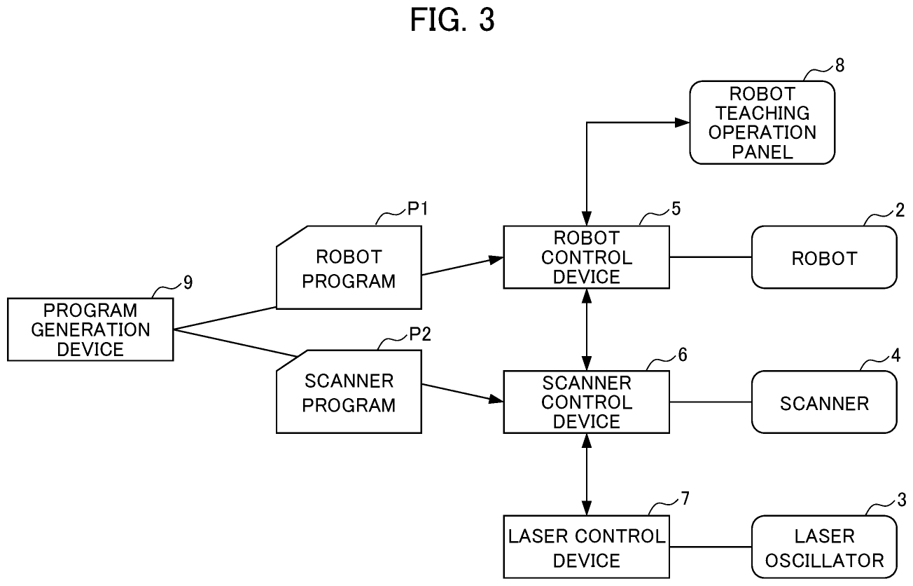

The program generation device 9 is connected to the robot control device 5 and the scanner control device 6, and generates programs for the robot 2 and the scanner 4. The program generation device 9 will be described in detail with reference to FIG. 3. In the present embodiment, it is assumed that at least the scanner 4, and preferably also the robot 2, are adjusted so as to operate accurately in response to commands of the programs.

FIG. 3 is a block diagram showing the functional configuration of the laser processing system 1 according to the present embodiment. As described above, the laser processing system 1 includes the robot 2, the laser oscillator 3, the scanner 4, the robot control device 5, the scanner control device 6, the laser control device 7, the robot teaching operation panel 8, and the program generation device 9. Hereinafter, with reference to FIG. 3, the operations of the robot control device, the scanner control device 6, the laser control device 7, and the program generation device 9 will be described in detail.

The program generation device 9 generates a robot program P1 for the robot 2 and a scanner program P2 for the scanner 4 in a virtual workspace from CAD/CAM data. Further, the program generation device 9 generates a program for emitting a control point correction trajectory.

The generated robot program P1 and scanner program P2 are respectively transferred to the robot control device 5 and scanner control device 6. When the robot program P1 stored in the robot control device 5 is started by operating the robot teaching operation panel 8, a command is sent from the robot control device 5 to the scanner control device 6, and the scanner program P2 is also started.

The robot control device 5 outputs a signal when the robot 2 conveys the scanner 4 to a predetermined position. In response to the signal output from the robot control device 5, the scanner control device 6 drives the optical system in the scanner 4.

The scanner control device 6 commands the laser control device 7 to output a laser. The robot control device 5, the scanner control device 6, and the laser control device 7 synchronize the movement of the robot 2, the scanning of the laser beam axis, and the output of the laser beam by exchanging signals at appropriate timings.

The robot 2 and the scanner 4 share position information and time information, and control the laser irradiation point at a desired position in the workspace. Further, the robot 2 and the scanner 4 start and end laser irradiation at appropriate timings. Thus, the laser processing system 1 can perform laser processing such as welding.

The program generation device 9 incorporates 3D modeling software. The operator can operate the models of the robot 2 and the scanner 4 on the computer to check the laser irradiation point, coordinate values, and so on.

Further, the program generation device 9 generates a 3D model of the workpiece 10 using the CAD data of the workpiece and sets one or more control points on the 3D model of the workpiece 10. Then, the program generation device 9 defines a welding shape with respect to the set control points.

As described above, since the path of the laser irradiation point can be considered to be represented by a sequence of points in the coordinate system with respect to the base of the robot in the workspace, these points can be referred to as control points. The control points may be on the path of the laser irradiation point, or may be points necessary to define the path of the laser irradiation point, not on the path of the laser irradiation point, such as the center of an arc.

Once the control points and the welding shape are defined, the program generation device 9 calculates the robot path along which the robot 2 moves and the scanning path of the laser irradiation point by the scanner 4.

With respect to the laser irradiation point in the three-dimensional space, the posture of the robot 2 and the rotation angles of the galvano motors 41a and 42a at the laser irradiation point by the scanner 4 are not uniquely determined. Therefore, the program generation device 9 includes an algorithm for searching for an optimal solution that satisfies conditions. The conditions in generating the robot program P1 and the scanner program P2 include shortening machining time, limiting the laser irradiation angle with respect to the workpiece 10, and limiting the posture range of the robot 2.

When the control point is corrected, the scanner control device 6 transmits the position information and the direction information of the corrected control point to the program generation device 9.

The program generation device 9 regenerates the robot program P1 and the scanner program P2 based on the position information and the direction information of the corrected control point using the above-described algorithm for searching for the optimal solution. The generated robot program P1 and scanner program P2 are transmitted to the scanner control device 6 again.

In this way, by generating the robot program P1 and the scanner program P2 reflecting the corrected control point, the program generation device 9 can correct the robot path in the robot program P1 and the irradiation path of the laser beam by the scanner 4 in the scanner program P2.

The program generation device 9 converts the scanner program into a control point correction program for correcting a preset control point. The control point correction program may be converted in advance from the scanner program in the program generation device 9, or may be converted from the scanner program once output by the program generation device 9.

The program generation device 9 executes, when converting the scanner program into the control point correction program, at least one of: changing the output condition of the laser beam, switching between the machining laser and the guide laser, or changing the scanning speed of the laser beam.

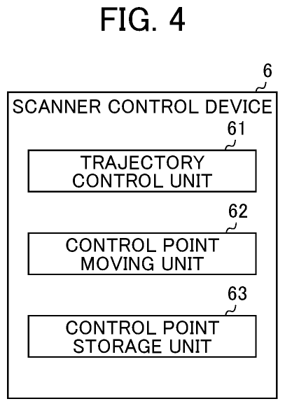

FIG. 4 is a block diagram showing the functional configuration of the scanner control device 6 according to the present embodiment. As shown in FIG. 4, the scanner control device 6 includes a trajectory control unit 61, a control point moving unit 62, and a control point storage unit 63.

The trajectory control unit 61 controls the scanner 4 based on the converted control point correction program so as to illuminate the workpiece 10 with a control point correction trajectory for correcting the control point in a state in which the robot 2 is stopped. The control point correction trajectory includes at least one of the control point, a path passing through the control point, or a path indicating the position of the control point.

The control point moving unit 62 moves the control point based on the control point correction trajectory, in accordance with the operation of the robot teaching operation panel 8. The control point storage unit 63 stores the position of the control point moved by the control point moving unit 62 and the direction defined by the moved control point in the coordinate system.

Based on the position of the control point and the direction of the control point in the coordinate system stored in the control point storage unit 63, the trajectory control unit 61 controls the scanner 4 to illuminate the workpiece 10 with the control point correction trajectory.

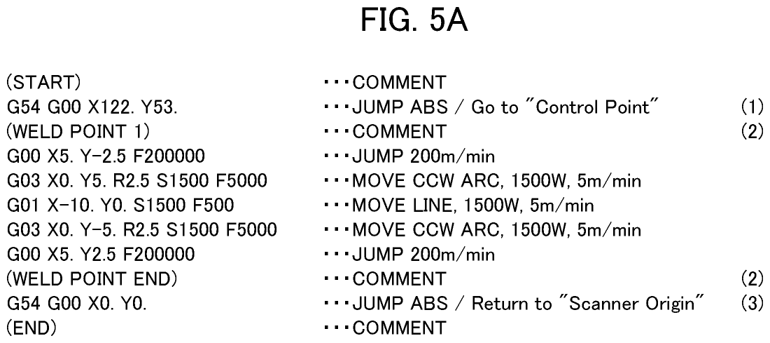

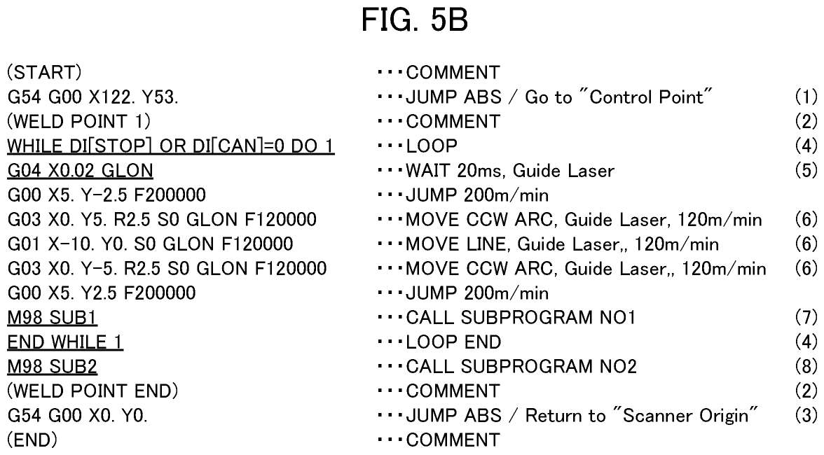

FIG. 5A shows an example of the scanner program before conversion, and FIG. 5B shows the control point correction program after conversion. In the programs shown in FIGS. 5A and 5B, examples of G codes are shown on the left side, and comments regarding G codes are shown on the right side.

In FIG. 5A, first, the scanner program moves the laser irradiation point to the control point by rapid traversing (see (1) in FIG. 5A). Then, the scanner program irradiates a welding position with a laser beam to start welding, and subsequently ends welding (see (2) in FIG. 5A).

When the welding at the welding position ends, the scanner program moves the laser irradiation point to the next welding position (see (3) in FIG. 5A).

In the control point correction program shown in FIG. 5B, the underlined G codes indicate programs added by being converted from the scanner program (see (4), (5), (7), and (8) in FIG. 5B).

Specifically, the control point correction program repeats the same trajectory for fast repetition of the control point correction trajectory (see (4) in FIG. 5B).

The control point correction program is stationary at the starting point for 20 ms before one scan of the control point correction trajectory, and emits a guide laser (see (5) in FIG. 5B).

The starting point is a control point, and the control point correction trajectory is defined in a coordinate system space whose origin is the control point.

Since the scanner program shown in FIG. 5A has a machining speed of 5 m/min, which is a slow scanning speed, the machining speed of the control point correction program shown in FIG. 5B is changed to 120 m/min.

Further, the control point correction program sets the machining laser to the interlock and output command 0 W (the S0 command in the control point correction program shown in FIG. 5B) to prevent the machining laser from being output and to output the guide laser (see (6) in FIG. 5B).

After one scan of the control point correction trajectory, the control point correction program calls a subprogram No. 1 to determine the movement of the control point correction trajectory (see (7) in FIG. 5B). The subprogram No. 1 changes the position and direction of laser irradiation at the subsequent welding point based on the operations regarding the parallel movement in the X, Y, and Z directions and the rotational movement of yaw, pitch, and roll with the robot teaching operation panel 8. The movement amounts of the changed position and direction are stored in the scanner control device 6.

When the operator moves the control point correction trajectory to a desired position and presses the stop button of the robot teaching operation panel 8, the position of the corrected control point correction trajectory is transferred to the program generation device 9, and the correction of the control point is completed.

At this time, if the correction is abandoned for some reason, the operator can cancel the correction of the control point by pressing the cancel button of the robot teaching operation panel 8. Since the position of the original control point is stored in the scanner control device 6, the operator can restart the work from the position of the original control point (see (8) in FIG. 5B).

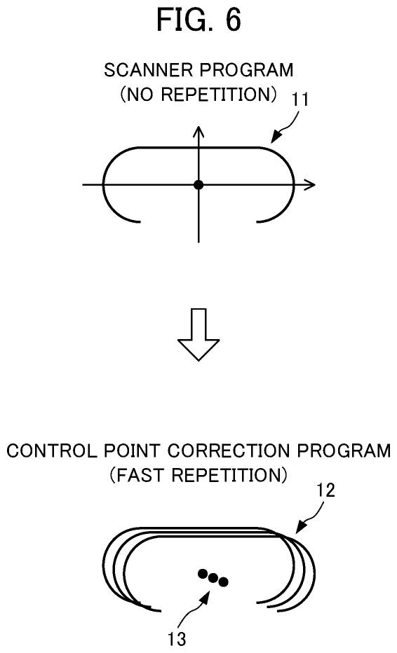

FIG. 6 shows an example of a control point correction trajectory emitted using the control point correction program. As shown in FIG. 6, the program generation device 9 converts the scanner program into the control point correction program, and the trajectory control unit 61 controls the scanner 4 so as to repeatedly scan a control point correction trajectory 12 at a predetermined cycle based on the converted control point correction program.

As described above, the scanner program before conversion does not repeatedly scan a machining trajectory 11 for laser irradiation, but the converted control point correction program repeatedly scans the control point correction trajectory 12 at a predetermined cycle. Here, the predetermined cycle preferably corresponds to, for example, a frequency of 10 Hz or more, and more preferably about 20 Hz, to obtain an afterimage effect. The control point correction trajectory 12 includes control points 13 as reference points. Thus, the operator can clearly visually recognize the control points 13 in the control point correction trajectory 12, and can appropriately correct the control points 13.

The laser processing system 1 may use a correction pattern to correct the control point correction trajectory illuminated on the workpiece 10. The correction pattern has the same length and shape as the control point correction trajectory, and can be disposed on the workpiece 10. The correction pattern may be, for example, a sticker that can be attached to the workpiece 10, a card-shaped article, a paper pattern, and a magnet that can be disposed on the workpiece 10. Alternatively, the correction pattern may be printed on the workpiece 10 in advance.

By using such a correction pattern, the control point correction trajectory illuminated on the workpiece 10 can be compared with the correction pattern having the same length and shape as the control point correction trajectory in the scanner program for controlling the scanner 4.

Thus, the operator can check and correct the position, direction, size, and distortion of the control point correction trajectory by comparing the control point correction trajectory illuminated on the workpiece 10 with the control point correction trajectory in the scanner program.

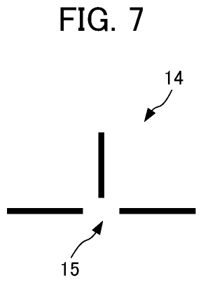

FIG. 7 shows another example of a control point correction trajectory emitted using the control point correction program. As shown in FIG. 7, the control point correction trajectory 14 includes three linear trajectories. The control point correction trajectory 14 further includes a path that clearly indicates the position of a control point 15. Specifically, the control point correction trajectory 14 defines, as the control point 15, an intersection at which line segments obtained by extending the three linear trajectories intersect. Thus, the operator can clearly visually recognize the control point 15 in the control point correction trajectory 14, and can appropriately correct the control point 15.

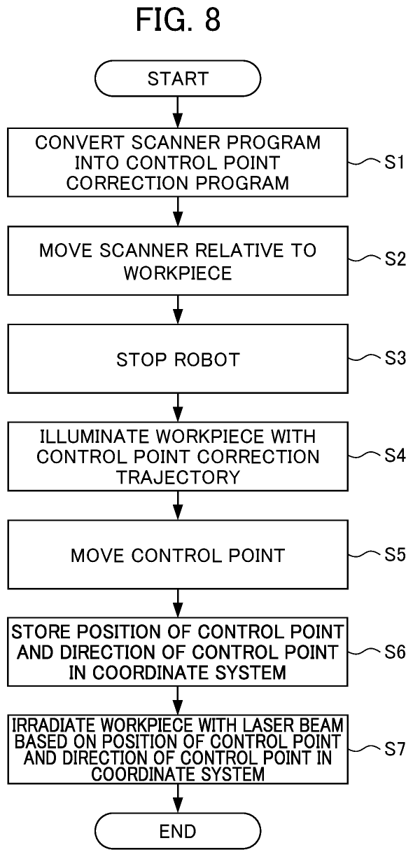

FIG. 8 is a flowchart showing the flow of processing of the laser processing system 1 according to the present embodiment. In Step S1, the program generation device 9 converts a scanner program into a control point correction program for correcting a preset control point.

In Step S2, the robot control device 5 controls the robot 2 based on a robot program so as to move the scanner 4 capable of scanning the workpiece 10 with a laser beam, relative to the workpiece 10.

In Step S3, the robot control device 5 controls the robot 2 to stop based on the robot program. In Step S4, the trajectory control unit 61 controls the scanner 4 based on the control point correction program so as to illuminate the workpiece 10 with a control point correction trajectory in a state in which the robot 2 is stopped.

In Step S5, the control point moving unit 62 moves the control point based on the control point correction trajectory. In Step S6, the control point storage unit 63 stores the position of the moved control point and the direction defined by the moved control point in a coordinate system.

In Step S7, the trajectory control unit 61 controls the scanner 4 to illuminate the workpiece 10 with the control point correction trajectory based on the position of the moved control point and the direction of the moved control point in the coordinate system.

As described above, the laser processing system 1 according to the present embodiment includes the scanner 4 capable of scanning the workpiece 10 with a laser beam, the robot 2 that moves the scanner 4 relative to the workpiece 10, the scanner control device 6 that controls the scanner 4, and the program generation device 9 that generates a scanner program for controlling the scanner 4. The program generation device 9 converts the scanner program into a control point correction program for repeatedly scanning a control point correction trajectory for correcting a preset control point at a predetermined cycle. The scanner control device 6 includes the trajectory control unit 61 that controls the scanner 4 based on the control point correction program so as to illuminate the workpiece 10 with the control point correction trajectory for correcting a control point in a state in which the robot 2 is stopped.

In this way, the laser processing system 1 can emit the control point correction trajectory using the control point correction program converted from the scanner program and correct the control point using the control point correction trajectory.

Further, the laser processing system 1 can correct a control point, that is a reference point for irradiating the workpiece 10 with a laser beam, by only the operation of the scanner 4 without moving the robot 2. Accordingly, the laser processing system 1 can easily correct the path of the laser irradiation point by correcting the control point.

Further, the laser processing system 1 repeatedly scans the control point correction trajectory, and thus the operator can visually recognize the path corresponding to the actual laser processing path, and therefore, can correct the control point over time accurately.

Further, with regard to the laser processing system 1, since the operator of the laser processing system 1 corrects the control point by visually recognizing the machining shape actually machined by the laser processing system 1, the operator can correct the control point while checking the positional relationship with the workpiece 10 and a jig. For example, when a narrow flange is laser-welded, the operator can see that the machining path is located within the flange.

Further, with the laser processing system 1, the actual machining shape can be checked, and thus not only the position of the machining shape but also the orientation of the machining shape can be checked. Further, conventional teaching correction employs a teaching jig or a plurality of additional guide lasers that intersect, and the intersections can be visually recognized, while with the laser processing system 1 according to the present embodiment, as described above, teaching correction can be performed while visually recognizing the actual machining shape.

Further, the laser processing system 1 emits the control point correction trajectory using the control point correction program converted from the scanner program. Therefore, the operator of the laser processing system 1 can correct the control point by visually recognizing the machining shape actually machined by the laser processing system 1.

The laser processing system 1 controls the scanner 4 to repeatedly scan the control point correction trajectory at a predetermined cycle. Thus, the afterimage effect allows the operator to perceive the control point correction trajectory as if it were continuously drawn. Accordingly, the operator perceives the control point correction trajectory, and thereby can check and correct the position, direction, size, and distortion of the control point correction trajectory.

The scanner control device 6 further includes the control point moving unit 62 that moves the control point based on the control point correction trajectory, and the control point storage unit 63 that stores the position of the moved control point and the direction defined by the moved control point in the coordinate system. The trajectory control unit 61 controls the scanner 4 to illuminate the workpiece 10 with the control point correction trajectory based on the position of the control point and the direction of the control point in the coordinate system.

Thus, the laser processing system 1 can correct the position of the control point and the direction of the control point in the coordinate system within the scanning range of the scanner 4 without moving the robot 2. Therefore, the laser processing system 1 can correct the control point by only scanning with a guide laser without changing the posture of the robot 2.

The control point correction trajectory illuminated on workpiece 10 has the same length and shape as the control point correction trajectory in the scanner program for controlling the scanner 4, and can be compared with the correction pattern that can be disposed on the workpiece 10. Thus, the operator compares the control point correction trajectory illuminated on the workpiece 10 with the control point correction trajectory in the scanner program, and thereby can check and correct the position, direction, size, and distortion of the control point correction trajectory.

The control point correction trajectory includes at least one of a control point, a path passing through the control point, or a path indicating the position of the control point. Thus, the operator can clearly visually recognize the control point in the control point correction trajectory, and can appropriately correct the control point.

The program generation device 9 executes, when converting the scanner program into the control point correction program, at least one of: changing the output condition of the laser beam, switching between the machining laser and the guide laser, or changing the scanning speed of the laser beam. Thereby, the laser processing system 1 enables the operator to easily visually recognize the control point correction trajectory emitted with the control point correction program.

The embodiments of the present invention have been described above, but the laser processing system 1 can be implemented by hardware, software, or a combination thereof. The control method performed by the laser processing system 1 can also be implemented by hardware, software, or a combination thereof. Here, “implemented by software” means that it is implemented by a computer reading and executing a program.

The program may be stored in various types of non-transitory computer readable media to be provided to the computer. The non-transitory computer readable media include various types of tangible storage media. Examples of the non-transitory computer readable media include magnetic recording media (e.g., hard disk drives), magneto-optical recording media (e.g., magneto-optical disks), CD-ROMs (read only memories), CD-Rs, CD-R/Ws, and semiconductor memories (e.g., mask ROMs, PROMs (programmable ROMs), EPROMs (erasable PROMs), flash ROMs, and RAMs (random access memories)).

Although the above-described embodiments are preferred embodiments of the present invention, the scope of the present invention is not limited to the above-described embodiments. Various modifications can be made without departing from the gist of the present invention.

### EXPLANATION OF REFERENCE NUMERALS

1 laser processing system
2 robot
3 laser oscillator
4 scanner
5 robot control device
6 scanner control device
7 laser control device
8 robot teaching operation panel
9 program generation device
10 workpiece
61 trajectory control unit
62 control point moving unit
63 control point storage unit

1. A laser processing system, comprising:
a scanner capable of scanning a workpiece with a laser beam;
a moving device configured to move the scanner relative to the workpiece;
a scanner control device configured to control the scanner; and
a program generation device configured to generate a scanner program for controlling the scanner,
wherein the program generation device converts the scanner program into a control point correction program for repeatedly scanning a control point correction trajectory for correcting a preset control point at a predetermined cycle, and
wherein the scanner control device comprises a trajectory control unit configured to control the scanner based on the control point correction program so as to illuminate the workpiece with the control point correction trajectory in a state in which the moving device is stopped.

2. The laser processing system according to claim 1,
wherein the scanner control device further comprises:
a control point moving unit configured to move the control point based on the control point correction trajectory; and
a control point storage unit configured to store a position of the moved control point and a direction defined by the moved control point in a coordinate system, and
wherein the trajectory control unit controls the scanner to illuminate the workpiece with the control point correction trajectory based on the position of the moved control point and the direction defined by the moved control point in the coordinate system.

3. The laser processing system according to claim 1, wherein the control point correction trajectory illuminated on the workpiece has the same length and shape as a control point correction trajectory in the scanner program for controlling the scanner, and can be compared with a correction pattern that can be disposed on the workpiece.

4. The laser processing system according to claim 1, wherein the control point correction trajectory includes at least one of the control point, a path passing through the control point, or a path indicating a position of the control point.

5. The laser processing system according to claim 1, wherein the program generation device executes, when converting the scanner program into the control point correction program, at least one of: changing an output condition of the laser beam, switching between a machining laser and a guide laser, or changing a scanning speed of the laser beam.

6. A method for controlling a laser processing system, the method comprising:
converting a scanner program for controlling a scanner into a control point correction program for correcting a preset control point;
moving the scanner capable of scanning a workpiece with a laser beam, relative to the workpiece;
stopping a moving device configured to move the scanner relative to the workpiece; and
controlling the scanner based on the control point correction program so as to illuminate the workpiece with a control point correction trajectory for correcting a preset control point in a state in which the moving device is stopped,
wherein controlling the scanner includes controlling the scanner to repeatedly scan the control point correction trajectory at a predetermined cycle.
